(19) United States
(12) Patent Application Publication
(10) Pub. No.: US 2009/0147515 A1
(43) Pub. Date: Jun. 11, 2009

(54) PRISM SHEET AND BACKLIGHT MODULE USING THE SAME

(75) Inventors: TUNG-MING HSU, Tu-Cheng (TW); SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,052

(22) Filed: Dec. 29, 2007

(30) Foreign Application Priority Data
Dec. 6, 2007 (CN) 200710202897.6

(51) Int. Cl. F21V 5/00; G02B 5/04

(52) U.S. Cl. 362/246; 359/831

(57) ABSTRACT

An exemplary prism sheet includes a transparent main body. The main body includes a first surface and a second surface. The first surface and the second surface are on opposite sides of the main body. The first surface defines a plurality of elongated, arc-shaped depressions. Each elongated, arc-shaped depression has a varying depth forming a first smooth wavy pattern. A plurality of elongated, arc-shaped protrusions protrudes from the second surface. Each elongated, arc-shaped protrusion has a varying height forming a second smooth wavy pattern. A backlight module using the present prism sheet is also provided.

### CROSS-REFERENCE TO RELATED APPLICATIONS

This application is related to eight co-pending U.S. patent applications, which are: application Ser. No. 11/938,307 and Ser. No. 11/938,308, filed on Nov. 12, 2007, and both entitled “PRISM SHEET AND BACKLIGHT MODULE USING THE SAME”; application Ser. No. 11/940,328, filed on Nov. 15, 2007, and entitled “PRISM SHEET AND BACKLIGHT MODULE USING THE SAME”, application Ser. No. 11/946,866 and Ser. No. 11/946,867, filed on Nov. 12, 2007, and both entitled “PRISM SHEET AND BACKLIGHT MODULE USING THE SAME”, and application Ser. No. 11/949,058, 11/949,059, and 11/949,060, filed on Dec. 3, 2007, and all entitled “PRISM SHEET AND BACKLIGHT MODULE USING THE SAME”. In the co-pending applications, the inventors are Tung-Ming Hsu and Shao-Han Chang. The co-pending applications have the same assignee as the present application. The disclosure of the above identified applications is incorporated herein by reference.

### BACKGROUND OF THE INVENTION

1. Field of the Invention

The present invention relates to prism sheets, particularly, to a prism sheet used in a backlight module.

2. Discussion of the Related Art

In a liquid crystal display device (LCD device), liquid crystal is a substance that does not itself illuminate light. Instead, the liquid crystal relies on light received from a light source to display information. In the case of a typical liquid crystal display device, a backlight module powered by electricity supplies the needed light.

FIG. 6 represents a typical direct type backlight module 100. The backlight module 100 includes a housing 11, a plurality of lamps 12 positioned above a base of the housing 11, and a light diffusion plate 13 and a prism sheet 10 stacked on top of the housing 11 in that order. Inside walls of the housing 11 are configured for reflecting certain of the light upwards. The light diffusion plate 13 includes a plurality of dispersion particles (not shown) therein. The dispersion particles are configured for scattering light, thus enhancing the uniformity of light exiting the light diffusion plate 13.

Referring to FIG. 7, the prism sheet 10 includes a base layer 101 and a prism layer 103 formed on the base layer 101. The prism layer 103 contains a plurality of parallel prism lenses 105 having a triangular cross section. The prism lenses 105 are configured for collimating received light to a certain extent. Typically, a method of manufacturing the prism sheet 10 includes the following steps: first, a melted ultraviolet (UV)-cured transparent resin is coated on the base layer 101 to form V-shaped lenses, then the melted ultraviolet-cured transparent resin is solidified to form the prism lenses 105.

In use, light from the lamps 12 enters the diffusion plate 13 and becomes scattered. Thus, scattered light leaves the light diffusion plate 13 to the prism sheet 10. The scattered light then travels through the prism sheet 10 and is refracted out at the prism layer 103 of the prism lenses 105. Thus, the refracted light leaving the prism sheet 10 is concentrated at the prism layer 103 and a brightness (illumination) of the prism sheet 10 is increased. The refracted light then propagates into an LCD panel (not shown) positioned above the prism sheet 10.

When the light is scattered in the light diffusion plate 13, scattered light enters the prism sheet at different angles of incidence. Referring to FIG. 8, when scattered light generally travels through the prism sheet 10 at different angles of incidence, the scattered light generally travels through the prism sheet 10 along three light paths. In the first light path (such as a₁, a₂) the light enters the prism sheet 10 at small angles of incidence and refracts out of the prism lenses 105 with the refracted path closer to the normal to the surface of the base layer. In the second light path (such as a3, a4) the light enters the prism sheet 10 at angles of incidence larger than the first light path and refracts out of the prism lenses 105 with the refracted path being closer to the normal to the surface of the prism lenses 105. Both the first light path and the second light path contribute to the brightness of the LCD and the light utilization efficiency of the backlight model. However, in the case of the third light path (such as a₅, a₆), the light enters the prism sheets at angles greater than the second light path, such that when the refracted light in the third light path leaves the prism sheet 10 at the prism lenses 105, the refracted light impinges on the surface of adjacent prism lens 103 and reenters the prism sheet 10. Thus, light traveling along the third light path will eventually reenter the prism sheet 10 and may exit the prism sheet 10 on the same side the light entered. This third light path does not contribute to the light utilization efficiency of the backlight module 100. Further, the third light path may interfere with or inhibit other incident light, resulting in decreasing brightness of the backlight module 100.

What is needed, therefore, is a new prism sheet and a backlight module using the prism sheet that can overcome the above-mentioned shortcomings.

### SUMMARY

In one aspect, a prism sheet according to a preferred embodiment includes a transparent main body. The main body includes a first surface and a second surface. The first surface and the second surface are on opposite sides of the main body. The first surface defines a plurality of elongated, arc-shaped depressions. Each elongated, arc-shaped depression has a varying depth forming a first smooth wavy pattern. A plurality of elongated, arc-shaped protrusions protrudes from the second surface. Each elongated, arc-shaped protrusion has a varying height forming a second smooth wavy pattern.

In another aspect, a backlight module according to a preferred embodiment includes a plurality of lamps, a light diffusion plate, and a prism sheet. The light diffusion plate is positioned above the lamps and the prism sheet is stacked on the light diffusion plate. The prism sheet is same as described in a previous paragraph.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is a side, cross-sectional view of a backlight module using a prism sheet according to a first preferred embodiment of the present invention.

FIG. 2 is an isometric view of the prism sheet of FIG. 1.

FIG. 3 is a side, cross-sectional view of the prism sheet of FIG. 2, taken along line III-III.

FIG. 4 is a side, cross-sectional view of the prism sheet of FIG. 2, taken along line IV-IV.

FIG. 5 is a side, cross-sectional view of a prism sheet according to a second preferred embodiment of the present invention.

FIG. 6 is a side, cross-sectional view of a conventional backlight module employing a typical prism sheet.

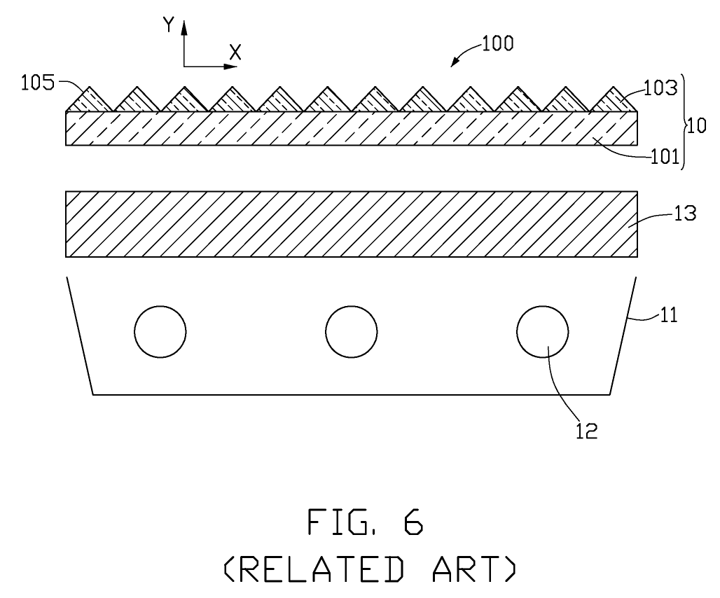

FIG. 7 is an isometric view of the prism sheet shown in FIG. 6.

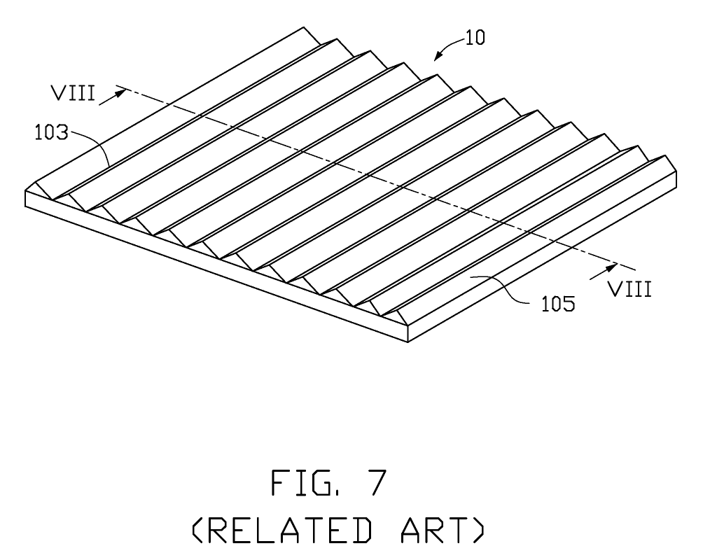

FIG. 8 is a side, cross-sectional view of the prism sheet of FIG. 7, taken along line VIII-VIII, showing light transmission paths.

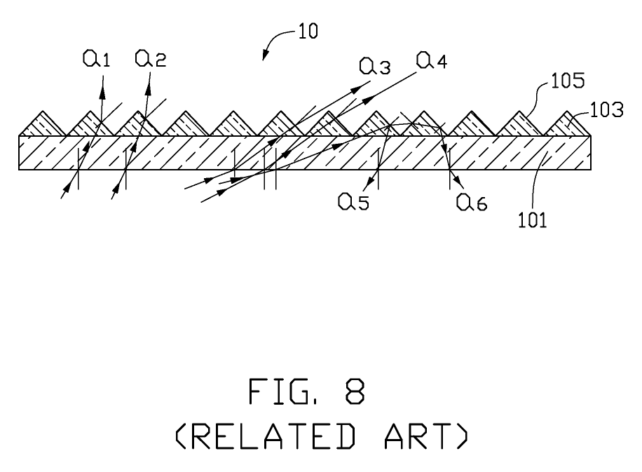

### DETAILED DESCRIPTION OF THE PREFERRED EMBODIMENTS

Reference will now be made to the drawings to describe preferred embodiments of the present prism sheet and backlight module, in detail.

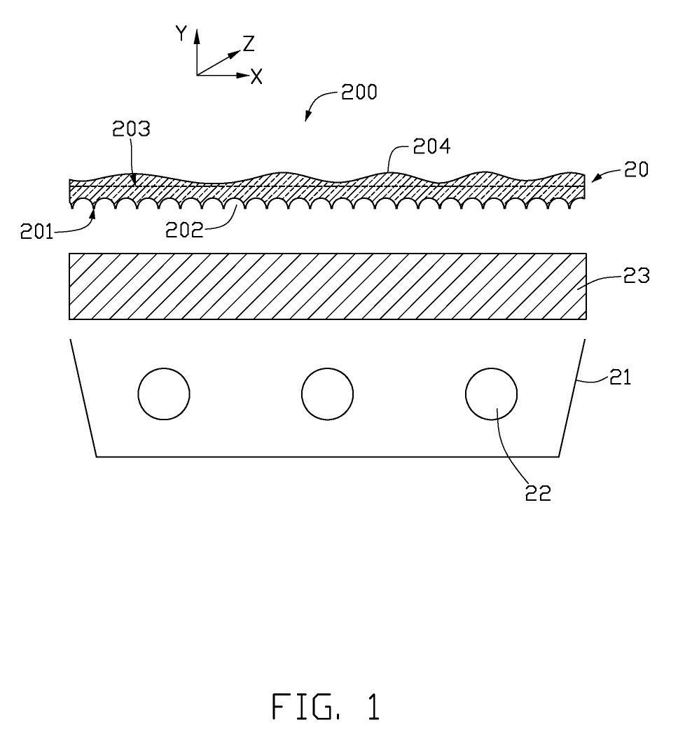

Referring to FIG. 1, a backlight module 200 in accordance with a first preferred embodiment of the present invention is shown. The backlight module 200 includes a prism sheet 20, a housing 21, a plurality of lamps 22, and a light diffusion plate 23. The lamps 22 are regularly aligned above a base of the housing 21. The light diffusion plate 23 and the prism sheet 20 are stacked on the top of the housing 21 in that order.

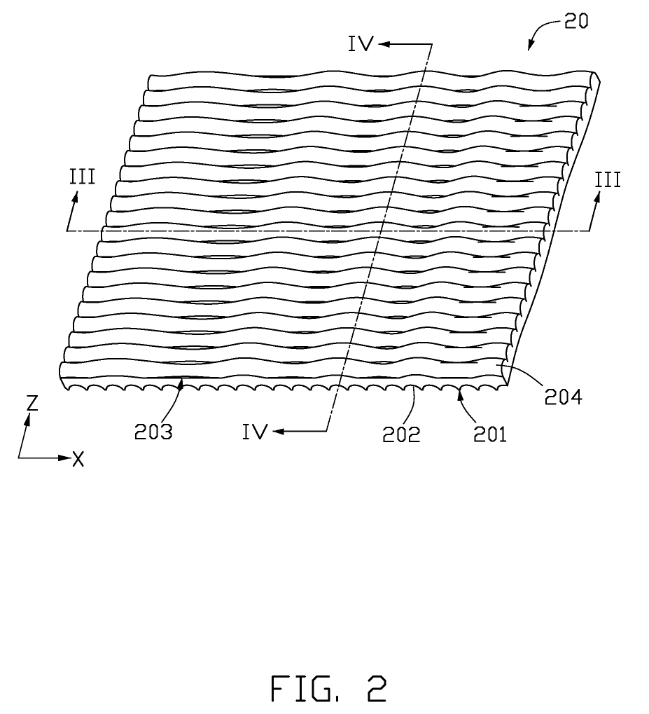

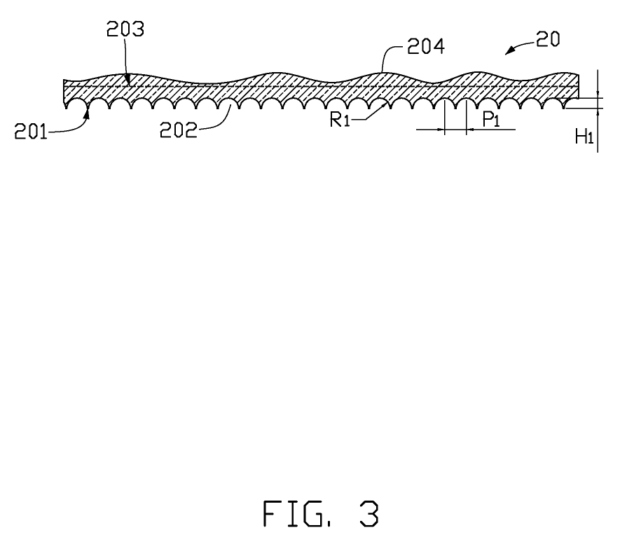

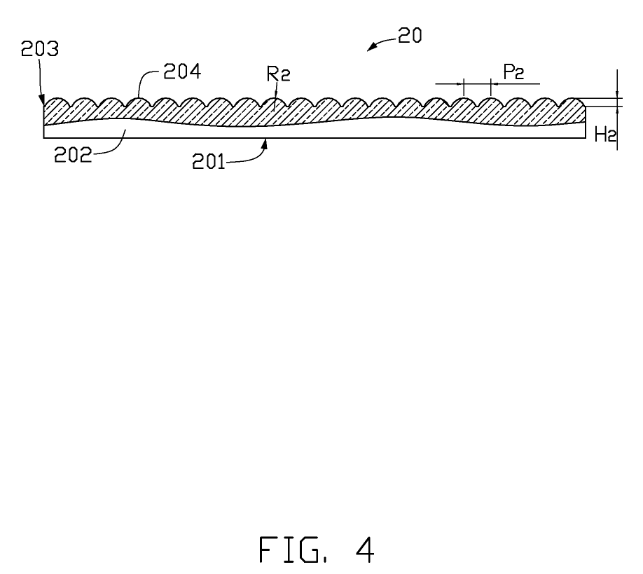

Referring to FIGS. 2 through 4, the prism sheet 20 includes a transparent main body. The main body includes a first surface 201 and a second surface 203. The first surface 201 and the second surface 203 are on opposite sides of the main body. Furthermore, the first surface 201 defines a plurality of elongated, arc-shaped depressions 202. Each elongated, arc-shaped depression 202 has a varying depth H₁ forming a first smooth wavy pattern. A plurality of elongated, arc-shaped protrusions 204 protrudes from the second surface 203. Each elongated, arc-shaped protrusion 204 has a varying height H₂ forming a second smooth wavy pattern. The prism sheet 20 is stacked on the light diffusion plate 23 in a way such that first surface 201 is adjacent to the light diffusion plate 23, and the second surface 203 faces away from the light diffusion plate 23. In the illustrated embodiment, an extending direction of the elongated protrusion 204 (X-direction) is perpendicular to an extending direction of the elongated, arc-shaped depression 202 (Z-direction). In alternative embodiments, the elongated, arc-shaped depression 202 and the elongated, arc-shaped protrusions 204 are both aligned obliquely relative to edges of the prism sheet 20.

The elongated, arc-shaped depressions 202 are configured for enabling the first surface 201 to converge incident light from the lamps 22 entering the prism sheet 20 to a certain extent (hereafter first light convergence). The elongated, arc-shaped depressions 202 are aligned side by side on the first surface 201 of prism sheet 20. Each of the elongated, arc-shaped depressions 202 has a semi-circular cross-section taken along a direction perpendicular to the extending direction thereof. A pitch P₁ between adjacent elongated, arc-shaped depressions 202 is configured to be in a range from about 0.025 millimeters to about 1.5 millimeters. A radius R₁ of a circular arc defined by the semi-circular cross section taken along a direction perpendicular to the extending direction of the elongated, arc-shaped depressions 202 is equal to or lager than 0.01 millimeters, and less than 3 millimeters. The depth H₁ of each elongated, arc-shaped depression 202 is equal to or larger than 0.01 millimeters, and less than 3 millimeters.

The elongated, arc-shaped protrusions 204 are configured for enabling the second surface 203 to converge light exiting the second surface 203 (hereafter second light convergence). The elongated, arc-shaped protrusions 204 are aligned side by side on the second surface 203 of prism sheet 20. Each of the elongated, arc-shaped protrusions 204 has a semi-circular cross section taken along a direction perpendicular to the extending direction of the elongated, arc-shaped protrusions 204. A pitch P₂ between adjacent elongated, arc-shaped protrusions 204 is configured to be in a range from about 0.025 millimeters to about 1.5 millimeters. A radius R₂ of a circular arc defined by the semi-circular cross section taken along a direction perpendicular to the extending direction of the elongated, arc-shaped protrusions 204 is equal to or larger than 0.01 millimeters, and less than 3 millimeters. The height H₂ of each elongated, arc-shaped protrusion 204 is equal to or larger than 0.01 millimeters, and less than 3 millimeters. In other alternative embodiments, adjacent elongated, arc-shaped protrusions 204 can be spaced apart from each other by a predetermined interval.

A thickness of the prism sheet 20 is preferably in a range from about 0.5 millimeters to about 3 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Again referring to FIG. 1, the lamps 22 can be point light sources such as light emitting diodes or linear light sources such as cold cathode fluorescent lamps. In the illustrated embodiment, the lamps 22 are cold cathode fluorescent lamps. The interior of the housing 21 is configured to be highly reflective.

In the backlight module 200, when light enters the prism sheet 20 via the first surface 201, the light undergoes the first light convergence at the first surface 201. Then the light further undergoes the second convergence at the second surface 203 before exiting the prism sheet 20. Thus, a brightness of the backlight module 200 is increased. In addition, due to the elongated, arc-shaped protrusions 204, most of the light exiting the prism sheet 20 would propagate along a direction paralleling the Y-direction or slight deviation therein. Thus, the light energy utilization rate of the backlight module 200 is high.

Moreover, in contrast to the conventional prism sheet, the prism sheet 20 of the present invention is integrally formed by injection molding technology. Injection molding technology allows the prism sheet 20 to be easier to mass-produce than that of the conventional prism. Conventional prism sheet are formed by solidifying melted ultraviolet-cured transparent resin and as such the prism lenses are easily damaged and/or scratched due to poor rigidity and mechanical strength. Then present prism sheet, when compared to the conventional prism sheet, has better rigidity and mechanical strength. Therefore, the present prism sheet 20 has a relative high reliability.

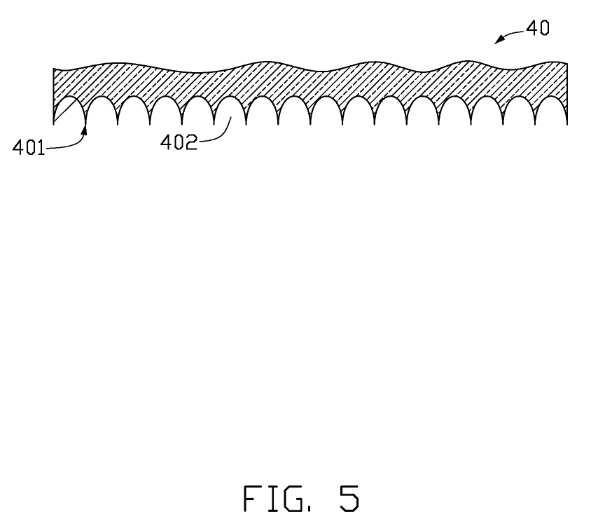

Referring to FIG. 5, a prism sheet 40 in accordance with a second preferred embodiment of the present invention is shown. The prism sheet 40 is similar in principle to the prism sheet 20. The first surface 401 defines a plurality of elongated, arc-shaped depressions 402. Each elongated, arc-shaped depression 402 has a varying depth forming a smooth wavy pattern. However, each of the elongated, arc-shaped depressions 402 has a semi-elliptical cross section taken along a direction perpendicular to an extending direction thereof.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body having:
a first surface,
a second surface opposite to the first surface,
plurality of elongated, arc-shaped depressions defined in the first surface, and a plurality of elongated, arc-shaped protrusions protruded from the second surface, wherein each elongated, arc-shaped depression has a varying depth forming a first smooth wavy pattern, and each elongated, arc-shaped protrusion has a varying height forming a second smooth wavy pattern.

2. The prism sheet according to claim 1, wherein each of the elongated, arc-shaped depressions has one of semi-elliptical and semi-circular cross section taken along a direction perpendicular to an extending direction thereof.

3. The prism sheet according to claim 1, wherein a depth of each elongated, arc-shaped depression is equal to or lager than about 0.01 millimeters, and less than about 3 millimeters.

4. The prism sheet according to claim 1, wherein the elongated, arc-shaped depressions are aligned side by side on the first surface of the prism sheet.

5. The prism sheet according to claim 1, wherein adjacent elongated, arc-shaped depressions are regularly spaced apart from each other.

6. The prism sheet according to claim 1, wherein an extending direction of each of the elongated protrusions is perpendicular to an extending direction of each of the elongated, arc-shaped depressions.

7. The prism sheet according to claim 1, wherein each of the elongated, arc-shaped protrusions has one of semi-elliptical and semi-circular cross section taken along a direction perpendicular to an extending direction thereof.

8. The prism sheet according to claim 1, wherein the elongated, arc-shaped protrusions are aligned side by side on the second surface of the prism sheet.

9. The prism sheet according to claim 1, wherein adjacent elongated, arc-shaped protrusions are regularly spaced apart from each other.

10. The prism sheet according to claim 1, wherein the prism sheet is made of transparent material selected from the group consisting of polycarbonate, polymethyl methacrylate, polystyrene, copolymer of methylmethacrylate and styrene, and any combination thereof, by injection molding.

11. A backlight module comprising:
a plurality of lamps;
a light diffusion plate positioned above the lamps; and
a prism sheet positioned on the light diffusion plate, the prism sheet including a transparent main body having
a first surface,
a second surface opposite to the first surface, and
a plurality of elongated, arc-shaped depressions defined in the first surface, and a plurality of elongated, arc-shaped protrusions protruded from the second surface, wherein each elongated, arc-shaped depression has a varying depth forming a first smooth wavy pattern, and each elongated, arc-shaped protrusion has a varying height forming a second smooth wavy pattern.

12. The backlight module according to claim 11, wherein the prism sheet is stacked on the light diffusion plate in a way such that first surface is adjacent to the light diffusion plate, and the second surface faces away from the light diffusion plate.

13. The backlight module according to claim 11, wherein each of the elongated, arc-shaped depressions has one of semi-elliptical and semi-circular cross section taken along a direction perpendicular to an extending direction thereof.

14. The backlight module according to claim 11, wherein each of the elongated, arc-shaped protrusions has one of semi-elliptical and semi-circular cross section taken along a direction perpendicular to an extending direction thereof.

15. The backlight module according to claim 1, wherein a depth of each elongated, arc-shaped depression is equal to or lager than about 0.01 millimeters, and less than about 3 millimeters.

16. The backlight module according to claim 11, wherein the elongated, arc-shaped protrusions are aligned side by side on the second surface of the prism sheet.

17. The backlight module according to claim 11, wherein adjacent elongated, arc-shaped protrusions are regularly spaced apart from each other.
